(19) United States
(12) Patent Application Publication
(10) Pub. No.: US 2006/0272458 A1
(43) Pub. Date: Dec. 7, 2006

(54) Self-locking auto-adjust pliers

(76) Inventor: Ara Don Kelly, Vancouver, WA (US)

Correspondence Address: Ara Kelly, P. O. Box 821717, Vancouver, WA, 98682, US

(21) Appl. No.: 11/236,002

(22) Filed: Sep. 26, 2005

Related U.S. Application Data
(60) Provisional application No. 60/613,468, filed on Sep. 27, 2004.

(51) Int. Cl. B25B 7/04; B25B 7/12

(52) U.S. Cl. 81/367; 81/362; 81/385

(57) ABSTRACT

A machine for Self-Adjusting Pliers with A gear reduction drive system, A soft smooth full cycle operation, A advanced ergonomic design, A fine power reduction locking gear, A faster work to Handel movement, A large gear reduction for ease of use, Suspension to ease work impact to user, Smooth direct drive reversible gears, Minimum links for smooth consistent operation, and Single rear pivot point for added strength.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of an advanced user hand tool design and more specifically to Self-Adjusting tools.

This invention relates to pliers, and, more particularly, to self-adjusting pliers that grips work pieces of various sizes with only a single-handed being used, they will automatically adjust and or lock the distance between the work end jaws to the size of the work piece.

U.S. Pat. No. 1,489,458 provides and improved pliers by adding the adjustible clamping pressure and locking feature.

U.S. Pat. No. 4,651,598 provides an improved pliers for adding an self adjusting jaws feature.

U.S. Pat. No. 6,279,431 provides an improved pliers by adding features semilar to the locking feature of the '458 and the self adjusting jaws of the '598

U.S. Pat. No. 6,095,019 provides an improved locking feature over the '431 by adding a semiautomatic clamping pressure adjustment.

The U.S. Pat. No. 4,651,598 tool has drawbacks. No locking feature.

The U.S. Pat. No. 6,279,431 tool has drawbacks. It is difficult to adjust the screw pressure adjust without using a second hand.

The U.S. Pat. No. 6,095,019 tool has drawbacks it has the same undesirable jaw angles found in the '458

With a radical new design and not just another attempt to improve on old existing designs it was possible to address these major drawbacks

Many of the main drawbacks the new design has overcome

First

The true one hand use

Many claim this, but are only referring to use and not other issues as the pressure adjustments needed by the old screw type feature used in the '431, '019 as well as many others

This design addresses these drawbacks by simply not using the old screw type adjustment

The fine locking lever action working with our solid drive gear never requires a second hand

Second

Easy smooth full cycle use.

The '598 tool has the same old style handles that are much larger on the user end than is practical. Especially on anything close to the large capacity of the jaws.

The user is put at a larger power disadvantage when they need it most, on the larger work.

The '431 tool has advanced features over the '598 as the locking feature, but the added parts to get the auto-adjustment comes at the expense of smooth use.

It will not function properly if you do not read and follow the instructions first. As they require you to apply pressure to a specified end of the tool first to begin proper closing The '019 tool has the same old style jaws where one is fixed and one moves. But the movable jaw rotates farther out of alignment the larger the work piece.

In many applications this is a disadvantage, as the jaw angle changes the grip become un-predictable

The new design has the user end of the tool fixed with a single pivot point eliminating the drawbacks associated with a less powerful user grip on the larger work where it is needed most. This design actually gives the user a smaller more comfortable and powerful grip on larger work by have the handles directly linked the the jaws on the work end. The larger the work the smaller and more powerful the user grip. The handle close at the same time the jaws of the work end open. This is the most advantageous design for the user. In fact even when the jaws are reversed in direction for a secure grip and or lock the handle continue in the closing direction.

Third

Safety thru ease of use and ergonomically designed handles

This most important area is where most other hand tool fall far short of the mark Major power enhancements were needed and are incorporated through gear reduction in this design

This addresses the many injuries from tools of this type coming from excessive pressure required on the users part

With very little pressure requirements on the users part as well as eliminating most or all pinch points in addition to an ergonomically design result in very little if any injuries to the user

Other enhancements

The fine locking requires little effort from the user

The function with one hand motion that being the closing motion for grip and locking make for a very simple use

The ergonomic design as well as suspension benefits makes this tool design fit for most any user or application

Further simplified use by adding common color codes I.E. red stop or lock, Green go or start etc.

The single pivot point opposite the work end makes the design complete by eliminating the draw back associated with too large a handle grip needed on the part of the user when you need it most, on a larger work piece

### BRIEF SUMMARY OF THE INVENTION

The primary object of the invention is A tool that requires less power from user.

Another object of the invention is A tool for safer use.

Another object of the invention is A tool that is smooth to use.

A further object of the invention is A tool that is easy to use.

Yet another object of the invention is A tool that is truly single hand use.

Still yet another object of the invention is A tool that has fine locking.

Another object of the invention is A tool that has full function with one hand motion.

Another object of the invention is A tool that has suspension to ease use.

A further object of the invention is A wherein, by way of illustration and example, an embodiment of the present invention is disclosed.

In accordance with a preferred embodiment of the invention, there is disclosed a machine for Self-Adjusting Pliers comprising: A gear reduction drive system, A soft smooth full cycle operation, A advanced ergonomic design, A fine power reduction locking gear, A faster work to Handel movement, A large gear reduction for ease of use, Suspension to ease work impact to user, Smooth direct drive reversible gears, Minimum links for smooth consistent operation, and Single rear pivot point for added strength tool that has simple use color codes.

Yet another object of the invention is A tool that has a single pivot point opposite the work end.

Other objects and advantages of the present invention will become apparent from the following descriptions, taken in connection with the accompanying drawings,

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan view of the invention.

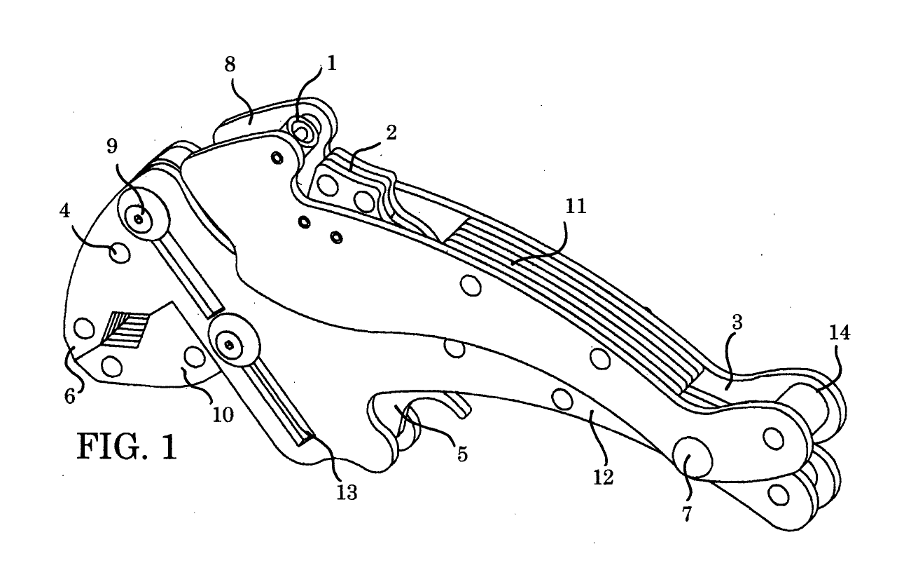

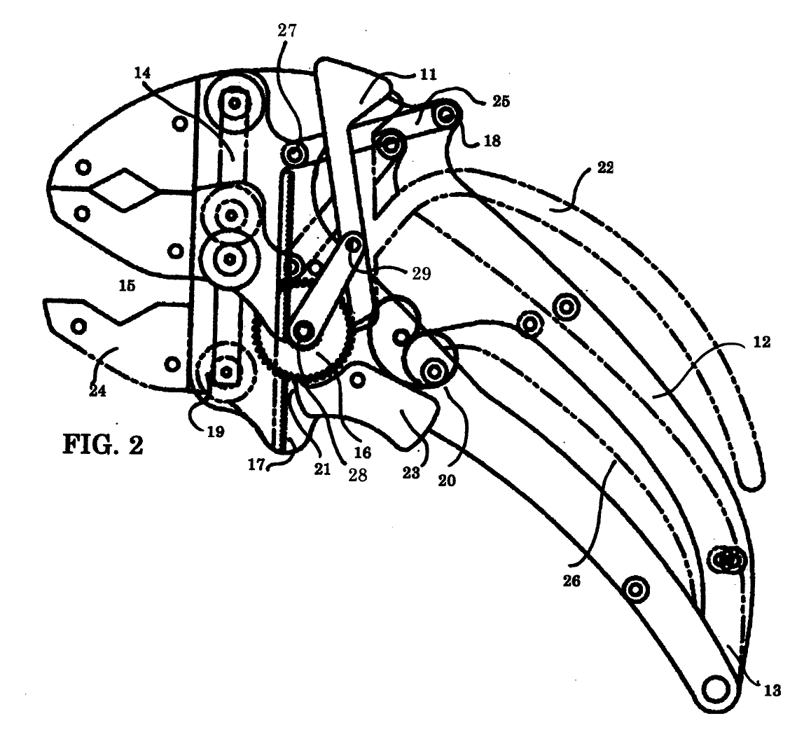

1 Compressible link

2 Gear reverse lever

3 main gear for reverse lever

4 Reduction gear drives work end

5 Jaw end of compression link

6 Compression spring

7 Rack end of reversing lever

8 Parallel slide for guide slot

9 Parallel guide slot

10 locking lever

11 Rack side of movable jaw

12 Rear single pivot point

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

A machine method for adding a simple and safe hand tool design while maintaining all the functionality and benefits of the existing designs

This design is a completely new and free from limitations of others as in the safe smooth function is not limited to a specific purpose but is adaptable to most. With the work end being made to grip, crimp, cut etc.

The overall design provides for a Self Adjusting work end as in Pliers comprising of a direct gear reduction drive system soft ergonomic handle design a smooth single closing action for a complete full cycle use operation with a reversible jaw action to accomplish the single user handle closing motion and a smooth action less links points between parts for a consistent predictable use

Advanced Power and Tool Strength

With the gear reduction option two or more gears would be used to accomplish a variety of needs suited to each specific tool task or need.

With a minimum of one large gear to the user end and one small gear to the work end With one or more suspension points in this design a must safer and user friendly tool emerges. Especially suited to holding a work piece that is being hammed or in any other way receiving shocking blows that would normally not be reduced on the users end of the tool

Far less effort on the users part adds to the safety as well as ease of use

Advanced Locking

With fine locking feature you no longer need the old style screw adjustment at the end opposite the work.

The locking lever being designed for easy release adds to the safety as well as ease of use

Single Rear Pivot Point

This unique feature always give the user a small comfortable grip

This only gets better in harmony with the size of the work piece.

The larger the work the smaller the handle size thus a more powerful grip size for the user

Suspension points

For a minimum impact or shock stress and far more comfort and safety to the user by way of one or more suspension points

Other improvements to future enhance safety as well as ease of use

The geometry between the user and the tool is maximized

In the handle to working jaws movement faster on the jaw ends which means less movement on the users part

In the locking lever the design also includes the simplest and easiest use for the direct safety and use benefit to the user

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A machine for Self-Adjusting Pliers comprising:
A gear reduction drive system;
A soft smooth full cycle operation;
A advanced ergonomic design;
A fine power reduction locking gear;
A faster work to Handel movement;
A large gear reduction for ease of use;
Suspension to ease work impact to user;
Smooth direct drive reversible gears;
Minimum links for smooth consistent operation; and
Single rear pivot point for added strength.
